(19) United States
(12) Patent Application Publication
(10) Pub. No.: US 2003/0072547 A1
(43) Pub. Date: Apr. 17, 2003

(54) Three dimensional prism image guide system for optical signal transmission

(75) Inventors: Karim Tatah, Winchester, MA (US); Kevin Tabor, Webster, MA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Schott Optovance, Inc., Southbridge, MA (US)

(21) Appl. No.: 10/040,587

(22) Filed: Dec. 28, 2001

Related U.S. Application Data
(60) Provisional application No. 60/328,649, filed on Oct. 11, 2001.

(51) Int. Cl. G02B 6/06; G02B 6/26

(52) U.S. Cl. 385/116; 385/47

(57) ABSTRACT

A three-dimensional prism image guide system for multiple optical signal transmission including a first prism formed from a fiber image guide having first and second ends, with the second end having first and second angled faces. A second prism formed from a fiber image guide is also provided with first and second ends. The first end has first and second angled faces. The first angled face of the first end of the second prism is in facing relationship to the second angled face of the second end of the first prism to form a first optical connection. A third prism is provided having first and second ends. The first end has at least a first angled face that is in facing relationship to the first angled face of the second end of the first prism to form a second optical connection.

### BACKGROUND

The present invention generally relates to optical signal transmission, and more particularly, to three-dimensional prism image guides for transmission of optical signals between signal emitters and detectors.

As the speed of computer processors increases, allowing faster and faster processing of data once it is received by the processor, the industry has increasingly looked to increasing the speed of data transmission to and from the processors since this has become the bottle neck for increasing the processing speed for the overall system. In order to increase data transmission rates, the use of fiber optics of optical data transmission has been proposed. Electrical signals are converted to optical signals via light emitting diodes, (LED's), vertical cavity surface emitting lasers (VCSEL) or through other means such that data can be transmitted at light speed between different processor or data handling devices.

It has been known to use fiber optic cables for transmission of optical data signals between processors. Such cables may be single optic fibers in which a plurality of multiplex signals are transmitted at the same time in one or both directions. Alternatively, it is possible to use a bundle of optic fibers to transmit one or more signals at the same time, with a single signal being carried by a single fiber of the bundled fiber group or a single signal being carried by multiple fibers if an over-sampling approach is utilized.

Fiber optic face places are also known in the industry for transmitting an image from one surface of the face plate to another surface of the face plate. Such face plates are utilized to cut down on transmission losses and signal divergence, as well as to protect the surface of an optic signal emitter or detector array provided in connection with a optoelectronic chips for receiving or emitting optical data signals.

It would be desirable to provide a simplified system for guiding optical signals between optoelectronic chips, such as in a multi-chip module, a PC board, a back plane connection or between PCT boards.

### SUMMARY

Briefly stated, the present invention provides a three-dimensional prism image guide system for multiple optical signal transmissions. The system includes a first prism comprising a fiber image guide formed from a fused bundle of optic fibers having first and second ends. The second end has first and second angled faces. A second prism comprising a fiber image guide formed from a fused bundle of optic fibers is also provided. The second prism has first and second ends. The first end of the second prism has first and second angled faces. The first angled face of the first end of the second prism is in facing relationship to the second angled face of the second end of the first prism to form a first optical connection. A third prism comprising a fiber image guide formed from a fused bundle of optic fibers is provided having first and second ends. The first end of the third prism has at least a first angled face. The first angled face of the first end of the third prism is in facing relationship to the first angled face of the second end of the first prism to form a second optical connection. In a preferred embodiment, the first, second and third fiber image guides provide multiple transmission channels for communication within or between optoelectronic devices.

In another aspect, the present invention provides a network topology having at least first and second three-dimensional prism image guide systems for multiple optical signal transmission. Each of the at least first and second three-dimensional prism image guide systems includes a first prism formed from a fused bundle of optic fibers having first and second ends. The first and second ends each have first and second angled faces. A second prism is provided which is formed from a fused bundle of optic fibers having first and second ends. The first end of the second prism has first and second angled faces. The first angled face of the first end of the second prism is in facing relationship to the second angled face of the second end of the first prism to form a first optical connection. The second end of the second prism is adapted for a connection to at least one of an optical signal emitter or detector. In the network topology, the second angled face of the second end of the first prism in the first three-dimensional prism image guide system is in facing relationship with the second angled face of the first end of the first prism of the second three-dimensional image guide system, and the first angled face of the first end of the first prism of the second three-dimensional image guide is in facing relationship with the second angled face of the first end of the second prism of the first three-dimensional image guide system. Further three-dimensional prism image guide systems may be added to the network topology to connect additional optical signal emitters and/or detectors.

### BRIEF DESCRIPTION OF THE DRAWINGS

The foregoing summary as well as the following detailed description of the preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements shown. In the drawings:

FIG. 1 is a view of a three-dimensional prism image guide system in accordance with the present invention.

FIG. 2 is an elevational view showing one prism of the three-dimensional prism image guide system of FIG. 1 having a reflective coating located on an angled end face.

FIG. 3 is a view similar to FIG. 1 showing a second embodiment of a three-dimensional prism image guide system in accordance with the present invention.

FIG. 4 is a view of a third embodiment of a three-dimensional prism image guide system in accordance with the present invention.

FIG. 5 is a view of a fourth embodiment of a three-dimensional prism image guide system in accordance with the present invention.

FIG. 6 is a schematic view of a network topology comprising a plurality of three-dimensional prism image guide systems for multiple optical signal transmission between optoelectronic chips.

FIG. 6a is a cross-sectional view taken along line 6a-6a in FIG. 6.

FIG. 7 is a schematic view of a second embodiment of a network topology including a plurality of three-dimensional prism image guide systems in accordance with the present invention.

### DETAILED DESCRIPTION OF THE PREFERRED EMBODIMENT(S)

Certain terminology is used in the following description for convenience only and is not considered limiting. The words “right”, “left”, “lower” and “upper” designate directions in the drawings to which reference is made. This terminology includes the words specifically noted above, derivatives thereof and words of similar import. Additionally, the terms “a” and “one” are defined as including one or more referenced item unless specifically noted otherwise.

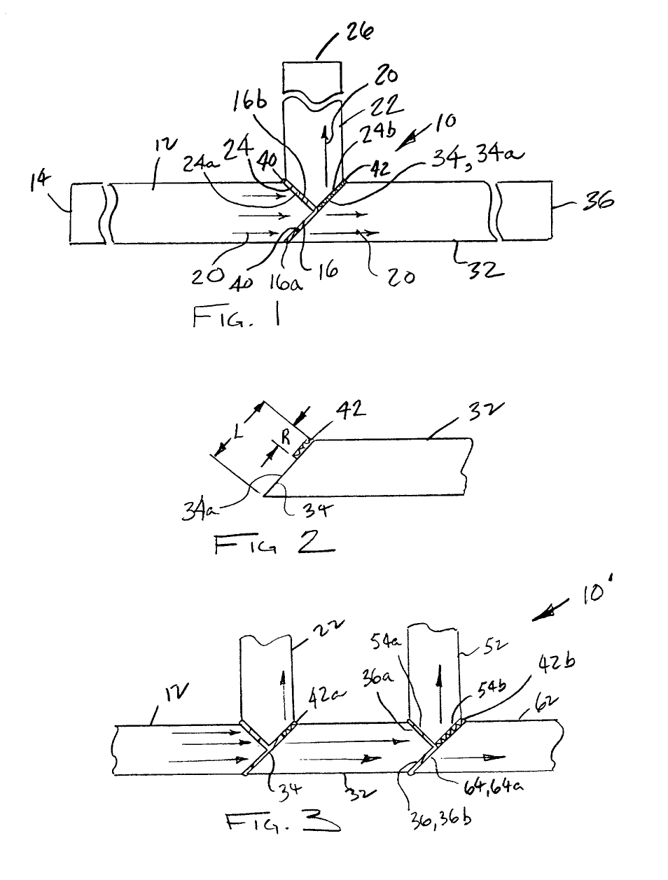

Referring now to FIG. 1, a three-dimensional prism image guide system 10 for multiple optical signal transmission is provided. The system includes a first prism 12 comprised of a fiber image guide formed from a fused bundle of optic fibers having first and second ends 14, 16. The second end 16 has first and second angled faces 16a, 16b. However, those skilled in the art will recognize from the present disclosure that more than two angled faces 16a, 16b may be provided, depending upon the particular system configuration, and that the angled faces could be both in-plane (as shown), out of plane, or a combination thereof. Preferably, the first prism image guide is formed of a glass material and has a prismatic shape.

A second prism 22, which is also comprised of a fiber image guide formed from a fused bundle of optic fibers, is provided, and includes first and second ends 24, 26. The first end 24 of the second prism 22 includes first and second angled faces 24a, 24b. The first angled face 24a of the first end 24 of the second prism 22 is in facing relationship to the second angled face 16b of the second end 16 of the first prism 12 to form a first optical connection. The second prism 22 may be formed in a similar manner to the first prism.

A third prism 32, which also comprises a fiber image guide formed from a fused bundle of optic fibers, is provided, and includes first and second ends 34,36. The first end 34 of the third prism 32 has at least a first angled face 34a. However, it would be recognized by those skilled in the art from the present disclosure that more than one angled face 34 may be provided on the first end 34 of the third prism 32. The first angled face 34a on the first end of the third prism 32 is in facing relationship to the first angled face 16a of the second end 16 of the first prism 12 to form a second optical connection. Preferably, an optically transmissive material such as a high optical transmission epoxy or UV curable adhesive 40 is used at the interface between the first, second and third prisms 12, 22, 32. Additionally, preferably a reflective coating 42 is located on at least a portion of one of the first and second angled faces of one of the first, second and third prisms 12, 22, 32 which are formed by fiber image guides.

As shown in detail in FIG. 1, at least a portion of the optical signals transmitted from the direction of the first end 14 of the first prism 12 can be diverted into the second prism while a remaining portion of the signal 20 continue onwardly into the third prism 32. Such optical signals may be emitted from LED's, VCSEL's or other known optical signal transmission sources and may be received by one or more optical detectors located at the opposite ends of the three-dimensional prism image guide system 10. This type of image guide system architecture allows for pre-formed image guide prisms 12, 22, 32 to be assembled in order to form an optical transmission path between at least two, and preferably three or more, system components, such as opto-electronic chips in a data processing device.

In the preferred embodiment, as shown in FIG. 1, the first end 34a of the third prism 32 is also in facing relationship with the second angled face 16b of the second end 16 of the first prism 12 to form a third optical connection.

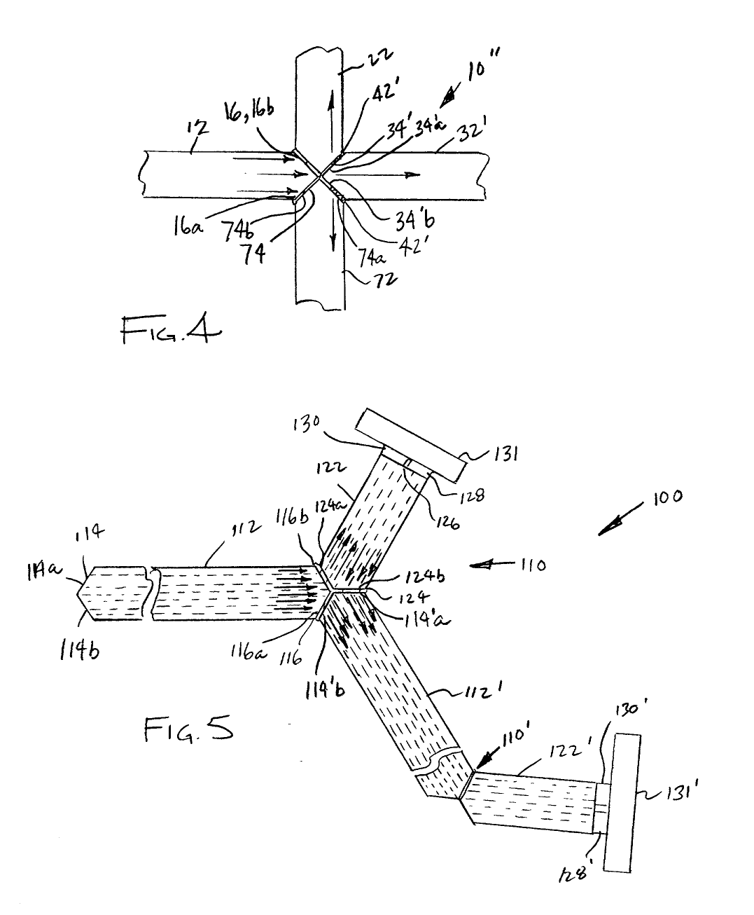

As shown in detail in FIG. 2, the width R of the reflective coating 42 on the first face 34a of the first end 34 of the third prism 32 can be varied between 0 and 100% of the overall width L of the face 34a. In the preferred embodiment, R is less than or equal to 50% of L.

While the first, second and third prisms 12, 22 and 32 are preferably comprised of fused bundles of optic fibers, any type of fiber image guide depending upon the particular application. Additionally, the system 10 may comprise a juncture of a network topology.

In FIG. 3, an embodiment of the prism image guide system 10′ is shown. The system 10′ is similar to the system 10 of FIG. 1, but the second end 36 of the third prism 32 has first and second end faces 36a, 36b. The length of the reflective coating 42a on the first end face 34a of the second prism extends for less than 25% of L such that only a portion of the optical signal being transmitted is reflected into the second prism 22. Fourth and fifth prisms 52, 62, which are similar to the second and third prisms 22 and 32 respectively, are optically connected to the second end 36 of the third prism 32. The first end 54 of the fourth prism has a first face 54a and a second face 54b. The first end 64 of the fifth prism 62 has at least a first end face 64a. The reflective coating 42b on the first angled face 64a on the first end 64 of the fifth prism 62 has a width R which is approximately 50% of the overall width L of the end face 64a. This allows a portion of the signal transmitted through the third prism 32 to be reflected into the fourth prism 52, and the remainder of the signal to be transmitted further along the prism image guide system 10′ via the fifth prism 62.

Those skilled in the will recognize from the present disclosure that additional prisms comprised of fiber image guides could be connected to the prism image guide system 10, 10′ to provide additional capability for signal transmission and branching.

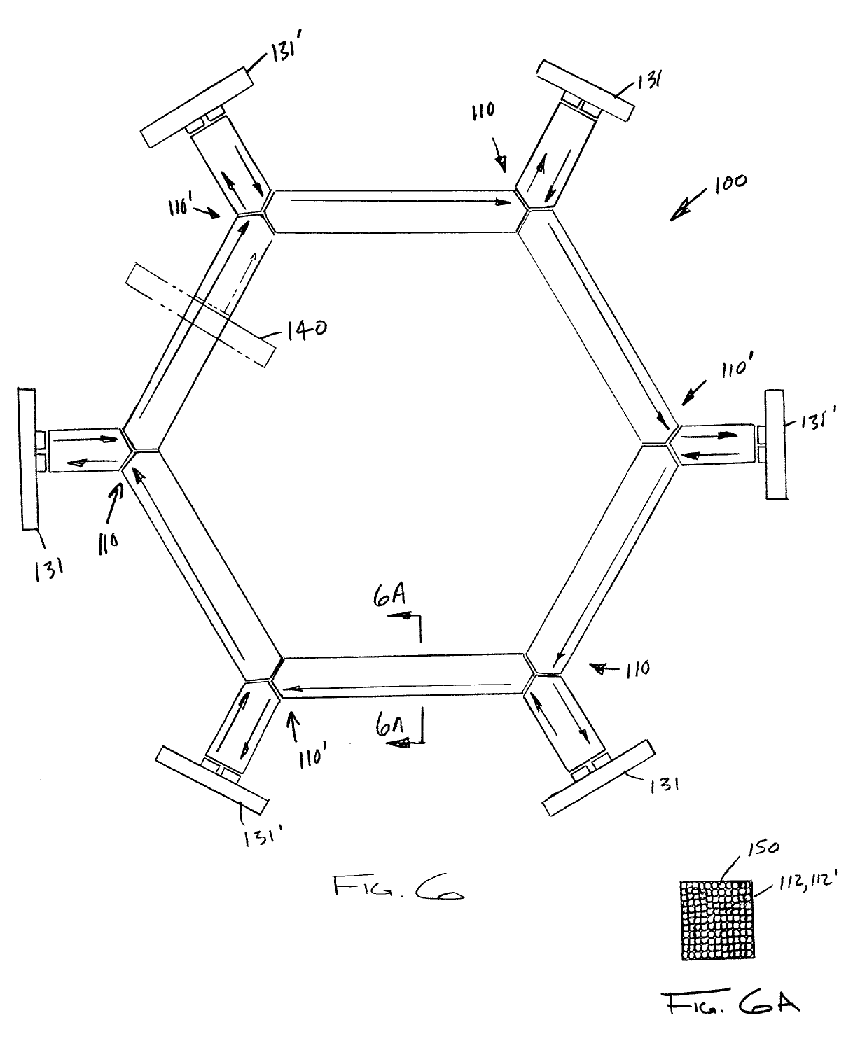

Referring to FIG. 4, a second alternate embodiment of the system 10″ is shown in which the first and second prisms 12, 22 are the same as described above in connection with the prism image guide system 10. However, in the system 10″, the third prism 32′ has a first end 34′ with first and second angled faces 34′a and 34′b. The reflective coating 42′ is applied over a portion of each of the first and second angled faces 34′a, 34′b. A fourth prism 72 is provided and includes a first end 74 having first and second angled faces 74a, 74b. The first angled face 74a of the fourth prism 72 is optically connected to the second angled face 34′b on the first end 34 of the third prism 32′. The second angled face 74b of the first end 74 of the fourth prism 72 is optically connected to the first angled face 16a on the first end 16 of the first prism 12. This provides a three-dimensional prism image guide system 10″ in the form of a four way juncture in which the incoming optical signal from the first prism 12 is reflected by the reflective coating 42′ into the second and fourth prisms 22, 72, and a portion of the optical signal continues through the juncture and into the third prism 32′. Those skilled in the art will recognize that the three-dimensional prism image guide systems 10, 10′ and 10″ can be used together in combination with one another to form various network topologies for communication of optical signals between optoelectronic devices for data signal transmission.

Referring now to FIG. 5, a fourth embodiment of a three-dimensional prism image guide system 110 is shown. The three-dimensional prism image guide system 110 includes a first prism 112 formed from a fused bundle of the optic fibers having first and second ends 114, 116. At least one of the first and second ends 114, 116, has first and second angled faces 114a, 114b and/or 116a, 116b. In a preferred embodiment, described in detailed below, both the first and second ends 114 and 116 have first and second angled faces 114a, 114b, 116a, 116b. The prism image guide system 110 further includes a second prism 122 formed from a fused bundle of optic fibers having first and second ends 124, 126. The first end 124 of the second prism 122 has first and second angled faces 124a, 124b. The first angled face 124a of the first end 124 of the second prism 122 is in facing relationship to the second angled face 116b of the second end 116 of the first prism to form a first optical connection. The second end 126 of the second prism 122 is adapted for connection to at least one of an optical signal emitter 128 or an optical signal detector 130. In a preferred embodiment, the second end 126 of the second prism 122 is connected to an optical signal emitter 128 and an optical signal detector 130, which may both be mounted on an optoelectronic device, such as an optoelectronic chip 131 to allow the reception and transmission of optical data.

A second three-dimensional prism image guide system 110′ having first and second prisms 112′, 122′ may be connected to the first three-dimensional prism image guide system 110 to form part or all of a network topology 100. The first angled face 116a of the second end 116 of the first prism 112 in the first three-dimensional prism image guide system 1110 is in facing relationship with the second angled face 114′b of the first end 114′ of the first prism 112′ of the second three-dimensional image guide system 110′. The first angled face 114′a of the first end 114′ of the first prism 112′ of the second three-dimensional prism image guide system 110′ is in facing relationship with the second angled face 124b of the first end 124 of the second prism 122 of the first three-dimensional image guide system 110. The second prism 122′ of the second prism image guide system 110′ may be connected to an optical signal emitter and/or detector 128′, 130′ of a second optoelectronic device 131′. This forms a network topology that can be used to link multiple optoelectronic devices 131, 131′.

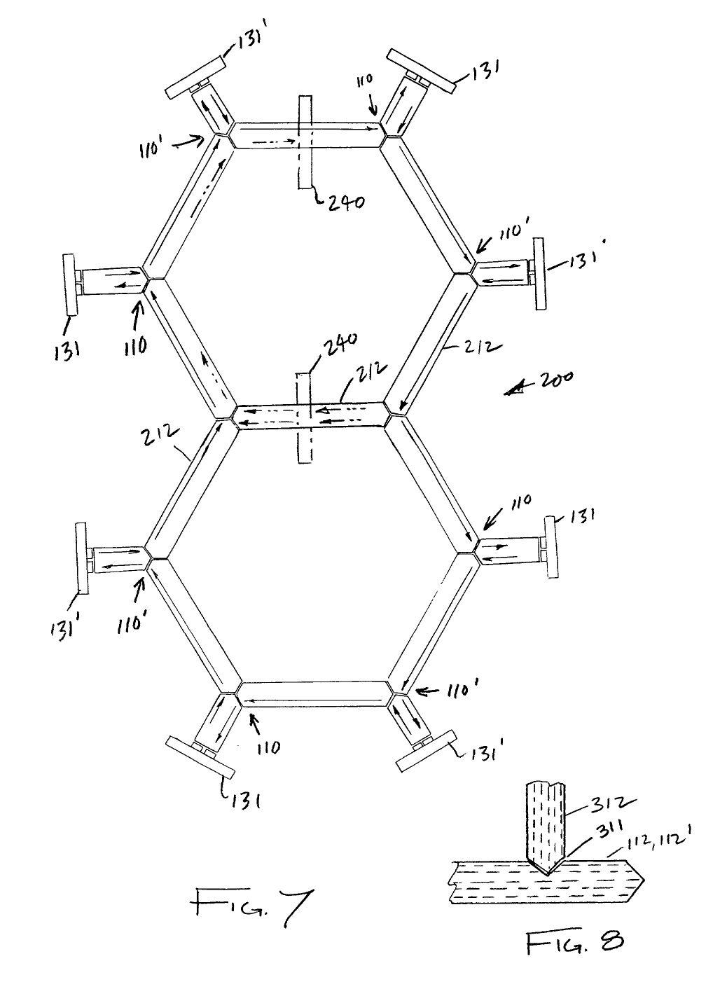

Additional prism image guide systems may be connected to the network topology 100, as illustrated in detail in FIG. 6. It would also be possible to have a starting or terminating end of a prism 112″ with a single face which can be connected to an optoelectronic device having emitters and/or detectors, such as device 140, shown in dashed lines in FIG. 6. For the sake of simplicity, the three-dimensional image guide systems 110, 110′ have been marked in alternate positions for the network topology 100 shown in FIG. 6. As shown in FIG. 6A, each prism 112, 112′ 122, 122′ is preferably formed of a fused bundle of optic fibers 150 to provide multiple signal transmission paths such that optical signals from multiple emitters and/or detectors can be simultaneously transmitted through the network topology. The third, fourth, fifth and sixth three-dimensional prism image guide systems are connected in a similar manner as the first and second prism image guide systems 110, 110′.

A second embodiment of the network topology 200 is shown in FIG. 7 utilizing the same three-dimensional prism image guide systems 110, 110′ of the previous embodiment 100. Additional straight prisms 212 formed in a similar manner to the first prisms 112 are utilized as additional bridging elements in order to connect the two ring network topology together. Alternatively, as shown in dashed lines, one or more of the prism image guides 112, 112′, 212 could be terminated in a single end face for connection to optoelectronic emitters and/or detectors 240, shown in broken lines.

Referring now to FIG. 7, any of the first and second prisms 112, 112′, 122, 122′ could include a V-groove for optical connection to a third prism 312 formed from a fused bundle of optic fibers. This could allow transmission and/or detection of signals at any point within a network topology.

Those skilled in the art will recognize from the present disclosure that other types of network topologies could be formed utilizing the three-dimensional image systems 10, 10′, 110, 110′ as well as the possibility of V-grooves 311 for optical connections to third prisms, such as the prism 312 which may be form part of a separate prism image guide system. This allows for easy formation of network topologies utilizing standardized prisms, which may be in the form of fused bundles of optic fibers for transmitting signals throughout a network topology.

Additionally, it will be recognized by those skilled in the art from the present disclosure that the prisms could have the end faces formed at different angles to allow connecting prisms to extend horizontally, vertically or at any acute angle to provide the ability for the prism image guide to extend in three-dimensions.

What is claimed is:

1. A three-dimensional prism image guide system for multiple optical signal transmission, comprising:
a first prism comprising a fiber image guide from a fused bundle of optic fibers having first and second ends, the second end having first and second angled faces;
a second prism comprising a fiber image guide from a fused bundle of optic fibers having first and second ends, the first end of the second prism having first and second angled faces, the first angled face of the first end of the second prism being in facing relationship to the second angled face of the second end of the first prism to form a first optical connection; and
a third prism comprising a fiber image guide from a fused bundle of optic fibers having first and second ends, the first end of the third prism having at least a first angled face, the first angled face of the first end of the third prism being in facing relationship to the first angled face of the second end of the first prism to form a second optical connection.

2. The system of claim 1 wherein a reflective coating is located on at least a portion of one of the first and second angled faces of at least one of the first, second and third fiber image guides.

3. The system of claim 1, wherein the first end of the third prism is in facing relationship with the second angled face of the second end of the first prism to form a third optical connection.

4. The system of claim 3, wherein the first, second and third fiber image guides are each comprised of a fused bundle of optic fibers and comprise a juncture of a network topology.

5. A network topology comprising at least a first and a second three-dimensional prism image guide system for multiple optical signal transmission, each of the at least first and second three-dimensional prism image guide systems comprising:
a first prism formed from a fused bundle of optic fibers having first and second ends, at least one of the first and second ends each having first and second angled faces, and
a second prism formed from a fused bundle of optic fibers having first and second ends, the first end of the second prism having first and second angled faces, the first angled face of the first end of the second prism being in facing relationship to the second angled face of the second end of the first prism to form a first optical connection, and the second end of the second prism being adapted for connection to at least one of an optical signal emitter or detector;
wherein the first angled face of the second end of the first prism in the first three-dimensional prism image guide system is in facing relationship with the second angled face of the first end of the first prism of the second three-dimensional image guide system, and the first angled face of the first end of the first prism of the second three-dimensional prism image guide system is in facing relationship with the second angled face of the first end of the second prism of the first three-dimensional image guide system.

6. The network topology of claim 5, further comprising a third three-dimensional prism image guide system, the second angled face of the second end of the first prism in the second three-dimensional prism image guide system is in facing relationship with the second angled face of the first end of the first prism of the third three-dimensional image guide system, and the first angled face of the first end of the first prism of the third three-dimensional image guide system is in facing relationship with the second angled face of the first end of the second prism of the second three-dimensional image guide system.

8. The network topology of claim 7, further comprising a fourth, fifth and sixth three-dimensional prism image guide systems in optical communication with the first, second and third three-dimensional prism image guide systems.

9. The network topology of claim 6, wherein at least one of the first and second prisms of the three dimensional image guide systems includes a V-groove for optical connection to a third prism formed from a fused bundle of optic fibers.
